(19) United States
(12) Patent Application Publication
(10) Pub. No.: US 2024/0141859 A1
(43) Pub. Date: May 2, 2024

(54) ENERGY STORAGE SYSTEM

(71) Applicant: John Sale Gilbert, Somers, NY (US)

(72) Inventor: John Sale Gilbert, Somers, NY (US)

(21) Appl. No.: 18/495,438

(22) Filed: Oct. 26, 2023

Related U.S. Application Data
(60) Provisional application No. 63/381,176, filed on Oct. 27, 2022.

(51) Int. Cl. F03B 13/06; F03B 13/10; F03B 13/26

(52) U.S. Cl. CPC F03B 13/06; F03B 13/105; F03B 13/26

(57) ABSTRACT

An energy storage system includes: a current flow energy recovery system configured to obtain energy from a moving water source; a storage tank configured to store fluid-based potential energy; and a pumping system configured to utilize the obtained energy to pump fluid from a fluid source into the storage tank, thus defining stored fluid.

### RELATED APPLICATION(S)

This application claims the benefit of U.S. Provisional Application No. 63/381,176, filed on 27 Oct. 2022, the entire contents of which are incorporated herein by reference.

### TECHNICAL FIELD

This disclosure relates to systems for storing energy and, more particularly, to systems for storing hydroelectric energy.

### BACKGROUND

Pumped Hydro Energy Storage (PHES) is a mature and extensively utilized method for storing and generating electricity. This grid energy storage approach harnesses the gravitational potential energy of water to store and release electricity when needed. The fundamental operation of PHES systems involves two water reservoirs at different elevations, typically an upper and a lower reservoir. During periods of surplus electricity generation, such as off-peak hours or when renewable sources produce excess power, the system uses electricity to pump water from the lower reservoir to the upper reservoir, effectively storing energy as potential energy. When electricity demand spikes, the stored water is released from the upper reservoir, flowing down to the lower reservoir through turbines, which generate electricity during the descent.

Pumped hydro energy storage systems serve a critical role for grid operators as they enable the storage of excess electricity during periods of low demand and its release when demand is high, contributing to grid stability and balancing. This ability to respond swiftly to demand fluctuations makes these systems an essential tool in grid management. They are also known for providing grid stability and serving as emergency backup power sources.

The history of pumped hydro energy storage traces back to the late 19th century, with significant development occurring in the mid-20th century. Iconic facilities, such as the TVA's Raccoon Mountain in the United States, which commenced operations in 1978, exemplify the adoption of this technology. Various countries, including Japan, Germany, and Switzerland, have established their pumped hydro facilities over the years.

These systems offer several advantages: they are highly efficient, with energy conversion efficiencies typically ranging from 70% to 85%, making them a cost-effective and reliable energy storage solution. Their operational lifespan often exceeds 50 years, and they provide a substantial energy storage capacity, rendering them suitable for large-scale grid applications. Moreover, they play a vital role in supporting the integration of renewable energy sources by mitigating their intermittency.

However, the deployment of pumped hydro energy storage does face challenges, primarily related to identifying suitable geographic locations with the necessary topographical and environmental conditions for reservoirs and efficient water cycling. Environmental concerns, including habitat disruption and water usage, must be addressed and regulated.

### SUMMARY OF DISCLOSURE

In one implementation, an energy storage system includes: a current flow energy recovery system configured to obtain energy from a moving water source; a storage tank configured to store fluid-based potential energy; and a pumping system configured to utilize the obtained energy to pump fluid from a fluid source into the storage tank, thus defining stored fluid.

One or more of the following features may be included. The current flow energy recovery system may be configured to gather energy from bidirectional tidal currents. The current flow energy recovery system may be configured to gather energy from monodirectional flowing currents. The current flow energy recovery system may include: a turbine generator that is rotated by the moving water source. The current flow energy recovery system may include: a flow concentration system for directing at least a portion of the moving water source into the turbine generator. The turbine generator may include: a bulb turbine generator. The storage tank may be positioned at least partially above the moving water source. The fluid may be water from the moving water source. The fluid source may be the moving water source. The obtained energy may be electrical energy and the pumping system may be an electrical pumping system. The obtained energy may be mechanical energy and the pumping system may be a mechanical pumping system. A drain system may be configured to drain a portion of the stored fluid within the storage tank, thus defining drained fluid. An electrical generation system may be configured to receive the drained fluid and generate electrical energy. The electrical generation system may include: a turbine generator that is rotated by the drained fluid.

In another implementation, an energy storage system includes: a current flow energy recovery system configured to obtain energy from a moving water source; a storage tank configured to store fluid-based potential energy; a pumping system configured to utilize the obtained energy to pump fluid from a fluid source into the storage tank, thus defining stored fluid; a drain system configured to drain a portion of the stored fluid within the storage tank, thus defining drained fluid; and an electrical generation system configured to receive the drained fluid and generate electrical energy.

One or more of the following features may be included. The current flow energy recovery system may be configured to gather energy from bidirectional tidal currents. The current flow energy recovery system may be configured to gather energy from monodirectional flowing currents. The current flow energy recovery system may include: a turbine generator that is rotated by the moving water source. The current flow energy recovery system may include: a flow concentration system for directing at least a portion of the moving water source into the turbine generator. The turbine generator may include: a bulb turbine generator. The storage tank may be positioned at least partially above the moving water source. The fluid may be water from the moving water source. The fluid source may be the moving water source. The obtained energy may be electrical energy and the pumping system may be an electrical pumping system. The obtained energy may be mechanical energy and the pumping system may be a mechanical pumping system. The electrical generation system may include: a turbine generator that is rotated by the drained fluid.

In one implementation, an energy storage system includes: a current flow energy recovery system configured to obtain energy from a moving water source, wherein the current flow energy recovery system includes a bulb turbine generator that is rotated by the moving water source; a storage tank configured to store fluid-based potential energy; a pumping system configured to utilize the obtained energy to pump fluid from a fluid source into the storage tank, thus defining stored fluid; a drain system configured to drain a portion of the stored fluid within the storage tank, thus defining drained fluid; and an electrical generation system configured to receive the drained fluid and generate electrical energy.

One or more of the following features may be included. The current flow energy recovery system may be configured to gather energy from bidirectional tidal currents. The electrical generation system may include: a turbine generator that is rotated by the drained fluid. The current flow energy recovery system may include: a flow concentration system for directing at least a portion of the moving water source into the turbine generator.

The details of one or more implementations are set forth in the accompanying drawings and the description below. Other features and advantages will become apparent from the description, the drawings, and the claims.

### BRIEF DESCRIPTION OF THE DRAWINGS

FIG. 1 is a diagrammatic view of an energy storage system configured for left-to-right water flow according to an embodiment of the present disclosure; and

FIG. 2 is a diagrammatic view of the energy storage system of FIG. 1 configured for right-to-left water flow according to an embodiment of the present disclosure.

Like reference symbols in the various drawings indicate like elements.

### DETAILED DESCRIPTION OF THE PREFERRED EMBODIMENTS

System Overview

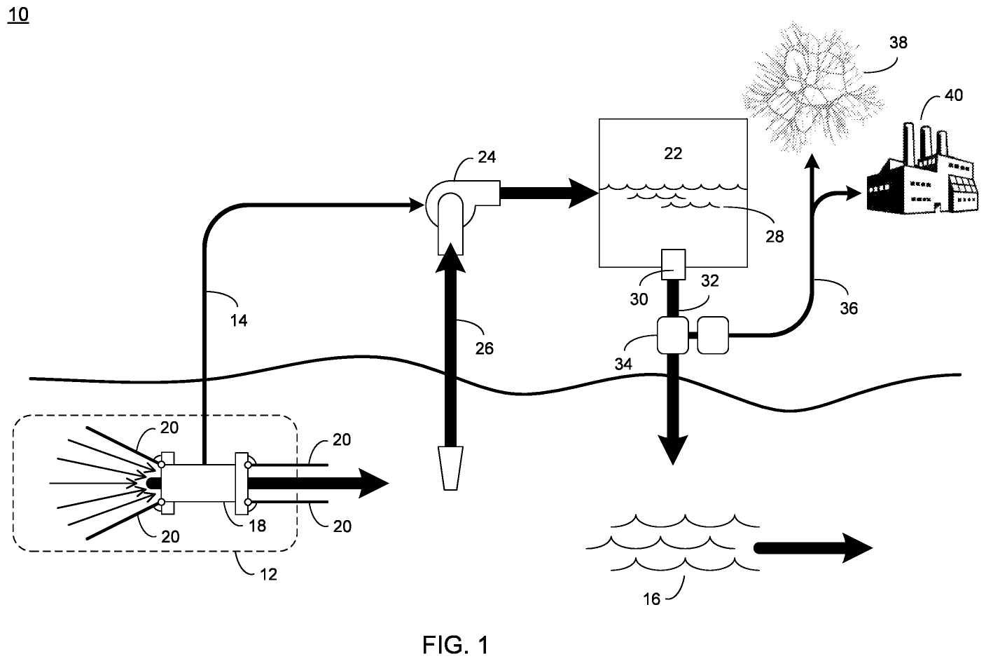

Referring to FIG. 1, there is shown an energy storage system (e.g., energy storage system 10). The energy storage system (e.g., energy storage system 10) may include a current flow energy recovery system (e.g., current flow energy recovery system 12) configured to obtain energy (e.g., obtained energy 14) from a moving water source (e.g., moving water source 16). In this particular figure, the movement (e.g., current) of the water source (e.g., moving water source 16) is from the left to the right.

The current flow energy recovery system (e.g., current flow energy recovery system 12) may be configured to gather energy from bidirectional tidal currents (e.g., moving water source 16). Bidirectional tidal currents, also referred to as reversible tidal currents, are a fundamental characteristic of tidal systems. Tides are the result of gravitational forces from the moon and the sun, causing predictable variations in water levels along coastlines and in estuaries. Bidirectional tidal currents describe the phenomenon where the direction of water flow changes with the rising and falling of the tide.

During the flood tide, water moves landward, toward the shore, as the incoming tide raises the water level. Conversely, during the ebb tide, water flows seaward, away from the shore, as the tide recedes, resulting in a reversal of water flow direction. Tidal slack, a brief period of minimal water movement, marks the transition between the flood and ebb tides when the tidal current velocity briefly comes to a standstill before reversing direction.

These bidirectional tidal currents are a common feature in many coastal regions and estuaries, influencing various marine and environmental processes. Their effects include navigation challenges, impacts on water quality, and implications for marine organisms that rely on tidal patterns for activities such as feeding, spawning, or migration. Moreover, bidirectional tidal currents can be harnessed for renewable energy generation through technologies like tidal stream turbines, which capture the kinetic energy of water movement to produce electricity during both the flood and ebb tides.

The largest tidal currents in the world are found in the Bay of Fundy, located on the eastern coast of North America between the Canadian provinces of New Brunswick and Nova Scotia. The Bay of Fundy is renowned for having the highest tides on the planet, with an average tidal range of about 16 meters (approximately 53 feet). These dramatic tidal fluctuations are a result of the bay's unique geography and the resonance of the tides within the bay.

The tidal currents in the Bay of Fundy are particularly powerful, with peak flow speeds exceeding 20 kilometers per hour (about 12.4 miles per hour) in some areas. The tides in the Bay of Fundy are primarily driven by the gravitational interaction of the Earth, the Moon, and the Sun, and the bay's funnel-like shape amplifies the tidal forces. As a result, the tidal currents in the Bay of Fundy are some of the most impressive and energetic in the world, making it a significant area for tidal energy research and development, as well as a natural wonder that attracts tourists and researchers interested in marine biology and environmental sciences.

Additionally/alternatively, the current flow energy recovery system (e.g., current flow energy recovery system 12) may be configured to gather energy from monodirectional flowing currents (e.g., moving water source 16). Monodirectional flowing currents, as their name implies, are characterized by a continuous and unchanging flow direction. Unlike bidirectional tidal currents that change with the tides, monodirectional currents maintain a constant path. These currents are a common feature in a range of aquatic environments and can be influenced by various factors, including wind, geographical topography, natural ocean currents, and artificial structures. For example, oceanic currents, such as the well-known Gulf Stream, exhibit unidirectional flow patterns as they travel consistently from one location to another. Similarly, river currents flow downstream in a continuous direction, dictated by the landscape's elevation gradient. Man-made canals, like the Panama Canal, are engineered to ensure water moves in one direction to facilitate transportation. Even wind-driven surface currents, influenced by prevailing winds, create monodirectional flows in bodies of water. Understanding monodirectional currents is vital for navigation, environmental management, and infrastructure design, as they have a substantial impact on water movement, aquatic ecosystems, and human activities in aquatic environments.

The current flow energy recovery system (e.g., current flow energy recovery system 12) may include: a turbine generator (e.g., turbine generator 18), such as a water-driven turbine generator, that is rotated by the moving water source (e.g., moving water source 16).

A water-driven turbine generator (e.g., turbine generator 18) is a type of power generation system that harnesses the kinetic energy of flowing water to produce electricity. This technology is commonly used in hydroelectric power plants and is a renewable and environmentally friendly source of energy.

Here's how a water-driven turbine generator (e.g., turbine generator 18) works:
Turbine: The heart of a water-driven turbine generator is the turbine itself. The turbine is a mechanical device with blades or buckets designed to capture the kinetic energy of moving water. The force of the flowing water causes the turbine to rotate.
Generator: Connected to the turbine is an electric generator. As the turbine spins, it turns the generator's rotor. This motion induces the generation of electricity within the generator's stator, where the mechanical energy is converted into electrical energy.
Electricity Production: The electricity produced is typically in the form of alternating current (AC) and is then transmitted to wherever needed. It can be used to power homes, businesses, and industries or stored in batteries for later use.

Water-driven turbine generators (e.g., turbine generator 18) are employed in various settings, including:
Hydroelectric Power Plants: Large-scale hydroelectric power plants use dams and reservoirs to control the flow of water. Water released from the reservoir flows through the turbines to generate electricity. These plants can provide a substantial amount of electrical power to regional grids.
Small Hydropower Installations: Smaller water-driven turbine generators are used in smaller, decentralized hydropower systems. These systems can be found in rural areas, remote communities, and even on individual properties to generate local, sustainable electricity.
Tidal and Wave Energy Systems: In regions with strong tidal or wave activity, water-driven turbines can be used to capture the energy of ocean tides and waves, generating electricity as a result.
Run-of-River Hydropower: Some systems, known as “run-of-river” hydropower, do not require dams or reservoirs. They use the natural flow of rivers or streams to turn turbines and generate electricity, often with less environmental impact compared to large dam projects.

Water-driven turbine generators are highly efficient and produce clean, renewable energy. They contribute to reducing greenhouse gas emissions and dependence on fossil fuels. However, the feasibility and environmental impact of such systems depend on factors like water flow, site location, and regulatory considerations.

An example of the turbine generator (e.g., turbine generator 18) may include but is not limited to: a bulb turbine generator. A bulb turbine generator (e.g., turbine generator 18), often simply called a “bulb turbine,” is a type of water turbine and generator used in hydroelectric power plants to convert the kinetic energy of flowing water into electricity. It's a specific design of a water turbine, known for its efficiency and ability to operate at low-head (small height difference between the water source and the generator) hydropower sites. The term “bulb” comes from the bulbous shape of the turbine and generator unit, which is partially submerged in the water.

Here's how a bulb turbine generator (e.g., turbine generator 18) works:
Turbine Blades: The heart of the bulb turbine is the set of turbine blades, which are designed to capture the kinetic energy of water. These blades are mounted on the hub of the turbine.
Bulb Housing: The bulb housing surrounds the turbine and contains the generator. This housing is usually partially submerged in the water, with the generator located in the bulbous section.
Water Flow: Water flows around the bulb housing, causing the turbine to spin as it passes over the blades. The spinning of the turbine is what converts the water's kinetic energy into mechanical energy.
Generator: Inside the bulb housing, the mechanical energy from the rotating turbine is transferred to a generator. The generator contains coils of wire and magnets, and the movement of the turbine rotor induces an electrical current to be generated in the coils.
Electricity Production: The electrical current generated is then transmitted to wherever needed after being conditioned and converted into a more suitable voltage. It can be used to power homes, industries, and various other electrical applications.

Bulb turbines are often used in low-head hydropower installations, such as those in rivers and estuaries where there isn't a significant drop in water level. They are known for their compact design, high efficiency, and minimal environmental impact, making them suitable for a variety of locations. Bulb turbines are particularly well-suited for locations where water flow is constant, as they can efficiently generate electricity under continuous, stable conditions.

The current flow energy recovery system (e.g., current flow energy recovery system 12) may include: a flow concentration system (e.g., flow concentration system 20) for directing at least a portion of the moving water source (e.g., moving water source 16) into the turbine generator (e.g., turbine generator 18). An example of a flow concentration system (e.g., flow concentration system 20) may include a funnel-shaped venturi system for directing at least a portion of the moving water source (e.g., moving water source 16) into the turbine generator (e.g., turbine generator 18).

In this particular example in which moving water source 16 is flowing from left to right, flow concentration system 20 is shown to include four gates, wherein the two left-most gates form a funnel for directing inbound water (shown as five flow arrows) to turbine generator 18. As the velocity of moving water source 16 increases/decreases, the inlet size of the funnel may be adjusted accordingly to maintain proper water flow to turbine generator 18.

A Venturi system (e.g., flow concentration system 20), in the context of fluid dynamics, is a device that employs the Venturi effect to concentrate and accelerate the flow of fluids, typically gases or liquids, through a constricted passage. It's named after its inventor, Giovanni Battista Venturi, an Italian physicist who first described the principle in the 18^{th} century.

The Venturi effect is based on Bernoulli's principle, which states that as the speed of a fluid increases, its pressure decreases. In a Venturi system, fluid flow is concentrated and accelerated as it passes through a narrowing in the pipe or tube.

The key components of a Venturi system (e.g., flow concentration system 20) include:
Inlet: This is where the fluid enters the Venturi system. It usually has a larger cross-sectional area.
Constriction or Throat: In the middle of the Venturi system, the passage narrows, creating a constriction point. This narrowing increases the fluid's velocity and reduces its pressure.
Outlet: After passing through the constriction, the fluid exits the Venturi system. The outlet section typically has a larger cross-sectional area than the throat.

Venturi systems (e.g., flow concentration system 20) are employed in various applications:
Fluid Measurement: Venturi meters are used to measure the flow rate of fluids, such as water or gases. The rate of fluid flow is determined by measuring the pressure difference between the inlet and throat, as this pressure difference is directly related to the flow rate.
Aircraft and Rocket Nozzles: In aerospace engineering, Venturi nozzles are used in aircraft and rocket propulsion systems to accelerate exhaust gases and create thrust. They are a vital component in jet engines and rocket engines.
Fluid Mixing: Venturi systems can be used for mixing two or more fluids. By creating a localized low-pressure region at the constriction point, they encourage thorough mixing of the fluids.
Aeration and Air Injection: Venturi systems can be utilized to introduce air or other gases into liquids for purposes such as water aeration, wastewater treatment, or gas injection in industrial processes.
Fuel Delivery in Internal Combustion Engines: Some carburetors and fuel injection systems in internal combustion engines use Venturi principles to mix fuel and air.

In summary, a Venturi system leverages the Venturi effect to concentrate and accelerate fluid flow through a constricted passage, and it finds application in various fields, including fluid measurement, propulsion, mixing, and aeration. The design of the system optimizes the flow dynamics to achieve desired results in different contexts.

The energy storage system (e.g., energy storage system 10) may include a storage tank (e.g., storage tank 22) configured to store fluid-based potential energy. A fluid storage tank (e.g., storage tank 22) is a container designed to store and hold large quantities of various types of fluids, such as liquids and gases. These tanks come in a wide range of sizes and shapes, depending on their intended use and the properties of the stored fluid. Common examples include water storage tanks, oil storage tanks, chemical storage tanks, and gas storage tanks. Fluid storage tanks serve several crucial purposes, such as providing a reserve of fluids for various applications, including industrial processes, water supply for municipalities, and fuel storage for energy generation. They are constructed from materials like steel, concrete, or plastic, and often feature safety measures to prevent leaks or spills. These tanks play a fundamental role in many industries, from agriculture to manufacturing, by offering a means to store and manage essential fluids efficiently and securely.

As will be discussed below in greater detail, the storage tank (e.g., storage tank 22) may be positioned at least partially above the moving water source (e.g., moving water source 16).

The energy storage system (e.g., energy storage system 10) may include a pumping system (e.g., pumping system 24) configured to utilize the obtained energy (e.g., obtained energy 14) to pump fluid (e.g., fluid 26) from a fluid source into the storage tank (e.g., storage tank 22), thus defining stored fluid (e.g., stored fluid 28). An example of the fluid (e.g., fluid 26) pumped into storage tank 22 may include but is not limited to water from the moving water source (e.g., moving water source 16). Accordingly, the fluid source may be the moving water source (e.g., moving water source 16).

The obtained energy (e.g., obtained energy 14) may be electrical energy and the pumping system (e.g., pumping system 24) may be an electrical pumping system. An electrical pump system (e.g., pumping system 24), often referred to as an electric pump system, is a mechanical system that utilizes an electric motor to generate mechanical work, which, in turn, powers a pump to move or pressurize fluids. These systems are widely used in various industries and applications to transport liquids, gases, or other fluids.

Here's how an electrical pump system (e.g., pumping system 24) typically works:
Electric Motor: At the heart of the system is an electric motor. This motor is powered by electricity, and its primary function is to convert electrical energy into mechanical energy.
Pump: Connected to the electric motor is a pump, which can come in various types, such as centrifugal pumps, diaphragm pumps, or positive displacement pumps. The pump's role is to create a flow of the fluid or gas by applying mechanical force, either by rotating impellers (as in centrifugal pumps) or by reciprocating motion (as in positive displacement pumps).
Fluid Transport: The fluid, whether it's water, oil, chemicals, or any other substance, is drawn into the pump through an inlet. The mechanical action of the pump creates pressure and moves the fluid through the system.
Outlet: The fluid is then discharged through an outlet, where it can be directed to its intended destination, such as supplying water to a household, circulating coolant in an industrial process, or transferring fuel in a storage tank.

Electrical pump systems (e.g., pumping system 24) find extensive use in various sectors, including:
Water Supply and Distribution: Electric pumps are commonly employed in municipal water supply systems, well pumps, and booster pumps to provide a reliable source of water for homes, businesses, and agricultural operations.
Industrial Processes: Many industrial processes, such as chemical manufacturing, food and beverage production, and HVAC systems, rely on electric pump systems to handle the movement and circulation of fluids and coolants.
Wastewater Management: Electric pumps are used in sewage and wastewater treatment facilities to move and treat wastewater and sludge.
Oil and Gas Industry: These systems are used to transport crude oil, refined products, and natural gas through pipelines and in various drilling and extraction processes.
Agriculture: Electric pumps play a critical role in irrigation systems, helping farmers distribute water to crops efficiently.
Environmental Control: Electric pump systems are vital in HVAC (heating, ventilation, and air conditioning) systems, providing temperature control and ventilation in buildings.

The choice of the specific type of pump and its size depends on the application and the characteristics of the fluid being handled. Electric pump systems are highly versatile and are designed to meet the specific needs of various industries, making them essential components in modern infrastructure and manufacturing processes.

Additionally/alternatively, the obtained energy (e.g., obtained energy 14) may be mechanical energy and the pumping system (e.g., pumping system 24) may be a mechanical pumping system. A mechanical pump system (e.g., pumping system 24) is a type of equipment that uses mechanical force to transfer or pressurize fluids, such as liquids or gases. It typically consists of a mechanical pump, which is operated using physical mechanisms, such as a piston or diaphragm, to create a flow or pressure in the fluid. These systems are widely used in various applications to move and manage fluids.

Here's an overview of how a mechanical pump system (e.g., pumping system 24) generally works:
Mechanical Pump: At the core of the system is a mechanical pump, which relies on physical components to create motion. These pumps can take various forms, including diaphragm pumps, piston pumps, gear pumps, or peristaltic pumps, among others.
Input Mechanism: The pump is powered by an input mechanism, which can be manual (like a hand pump), powered by an electric motor, or connected to an internal combustion engine.
Fluid Handling: The fluid to be moved or pressurized is drawn into the pump through an inlet. The mechanical action of the pump creates the necessary force to move or pressurize the fluid.
Outlet: The fluid is then discharged through an outlet and can be directed to the desired destination, whether it's supplying water to a well, distributing chemicals in an industrial process, or circulating coolant in a vehicle's engine.

Mechanical pump systems (e.g., pumping system 24) find widespread use in various industries and applications, including:
Agriculture: Hand or electrically operated mechanical pumps are used for irrigation, allowing farmers to deliver water to their fields.
Automotive: Mechanical pumps are used in vehicles to circulate coolant through the engine and to provide hydraulic power for systems like power steering and brakes.
Industrial Processes: They are commonly found in manufacturing processes, where they move fluids for chemical processing, material handling, and other applications.
Water Wells: Hand pumps are used in remote areas or where access to electricity is limited to draw water from wells.
Oil and Gas Industry: Mechanical pumps play a role in drilling, extraction, and the transportation of oil and natural gas.
Wastewater Management: They are utilized in sewage treatment plants for various fluid handling tasks.
Medical and Laboratory Equipment: Peristaltic pumps, a type of mechanical pump, are used in medical devices and laboratory equipment for precise fluid handling.

The choice of the specific type of mechanical pump and its size depends on the application's requirements and the characteristics of the fluid being handled. These systems are characterized by their mechanical simplicity and are valued for their reliability in many settings.

The energy storage system (e.g., energy storage system 10) may include a drain system (e.g., drain system 30) configured to drain a portion of the stored fluid (e.g., stored fluid 28) within the storage tank (e.g., storage tank 22), thus defining drained fluid (e.g., drained fluid 32). An example of drain system 30 may include but is not limited to an electrically controlled valve assembly. Accordingly, the stored fluid (e.g., stored fluid 28) is potential energy that may be utilized by draining some or all of the stored fluid (e.g., stored fluid 28) from storage tank 22.

The energy storage system (e.g., energy storage system 10) may include an electrical generation system (e.g., electrical generation system 34) configured to receive the drained fluid (e.g., drained fluid 32) and generate electrical energy (e.g., electrical energy 36). An example of the electrical generation system (e.g., electrical generation system 34) may include but is not limited to a turbine generator that is rotated by the drained fluid (e.g., drained fluid 32). Accordingly, the stored fluid (e.g., stored fluid 28) within storage tank 22 may be controllably drained (e.g., via drain system 30) from storage tank 22 to generate electrical energy 36 via electrical generation system 34.

Electrical energy 36 may be e.g., provided to an electrical grid (e.g., electrical grid 38). The electrical grid (e.g., electrical grid 38), commonly known as the power grid or electricity grid, is a complex and interconnected network that facilitates the generation, transmission, and distribution of electricity from power plants to end-users. It serves as the fundamental framework for modern electrical systems, ensuring the reliable supply of electrical energy to meet the diverse needs of consumers. The grid consists of several key components and functions, beginning with power generation at a variety of facilities, including coal, natural gas, nuclear, and renewable energy plants. These power generation sources convert different forms of energy into electrical power.

Following generation, electricity is transmitted over long distances via high-voltage transmission lines and substations to minimize energy loss. Transformers play a crucial role in stepping up and stepping down the voltage for efficient transmission and safe distribution. At the distribution level, electricity is delivered to local communities, businesses, and industries through a network of medium-voltage and low-voltage power lines. Distribution substations further reduce the voltage for safe delivery to end-users' homes and workplaces.

End-users utilize electricity for a wide range of purposes, including lighting, heating, cooling, machinery operation, and the operation of electronic devices. To ensure the grid's stable and reliable operation, grid operators and control centers continuously monitor and manage the flow of electricity in real-time. They make necessary adjustments to balance supply and demand and respond to fluctuations in electricity consumption. Moreover, the grid is designed to accommodate various sources of power generation and adapt to changes in electricity demand. With the integration of advanced technologies, such as smart grids, it aims to enhance efficiency, reliability, and the incorporation of renewable energy sources. The electrical grid is a cornerstone of modern society, powering homes, businesses, industries, and technological advancements, and it plays a pivotal role in economic development and infrastructure.

Additionally/alternatively, electrical energy 36 may be e.g., utilized to power local activities. For example, if the energy storage system (e.g., energy storage system 10) is installed at an industrial complex (e.g., industrial complex 40), electrical energy 36 may be utilized to power local activities at the industrial complex (e.g., industrial complex 40).

As discussed above and with respect to FIG. 1, moving water source 16 is shown to be flowing from left to right, wherein flow concentration system 20 is shown to include four gates. Due to such left to right movement, the two left-most gates form a funnel for directing inbound water (shown as five flow arrows) to turbine generator 18, wherein the inlet size of the funnel may be adjusted to maintain proper water flow to turbine generator 18 if the velocity of moving water source 16 increases/decreases.

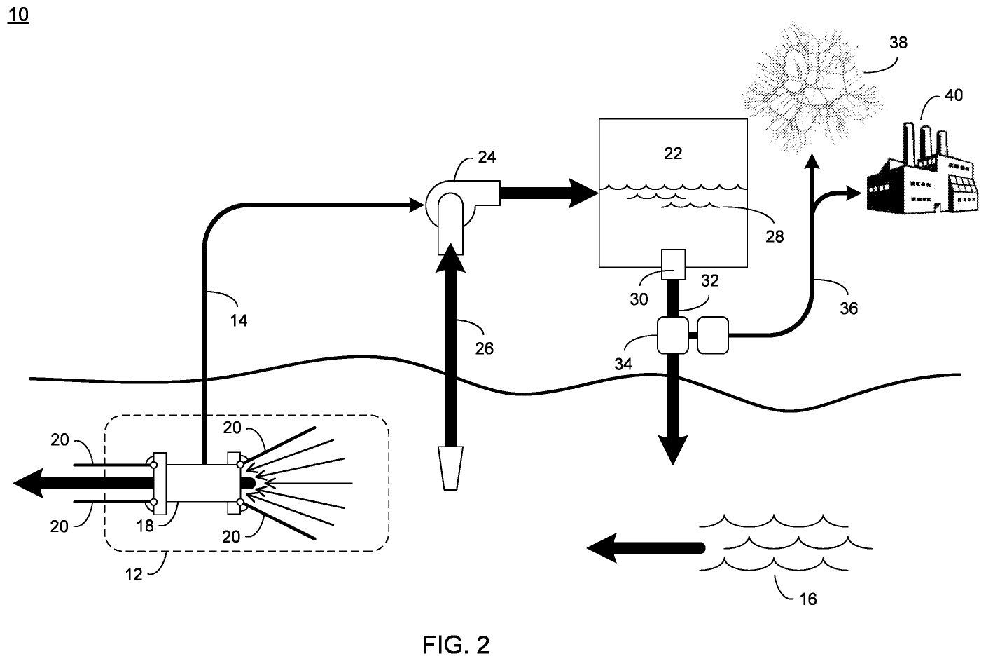

Referring also to FIG. 2, moving water source 16 is shown to be flowing from right to left, wherein flow concentration system 20 is shown to include four gates. Due to such right to left movement, the two right-most gates form a funnel for directing inbound water (shown as five flow arrows) to turbine generator 18, wherein the inlet size of the funnel may be adjusted to maintain proper water flow to turbine generator 18 if the velocity of moving water source 16 increases/decreases.

General

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present disclosure has been presented for purposes of illustration and description, but is not intended to be exhaustive or limited to the disclosure in the form disclosed. Many modifications and variations will be apparent to those of ordinary skill in the art without departing from the scope and spirit of the disclosure. The embodiment was chosen and described in order to best explain the principles of the disclosure and the practical application, and to enable others of ordinary skill in the art to understand the disclosure for various embodiments with various modifications as are suited to the particular use contemplated.

A number of implementations have been described. Having thus described the disclosure of the present application in detail and by reference to embodiments thereof, it will be apparent that modifications and variations are possible without departing from the scope of the disclosure defined in the appended claims.

What is claimed is:

1. An energy storage system comprising:
a current flow energy recovery system configured to obtain energy from a moving water source;
a storage tank configured to store fluid-based potential energy; and
a pumping system configured to utilize the obtained energy to pump fluid from a fluid source into the storage tank, thus defining stored fluid.

2. The energy storage system of claim 1 wherein the current flow energy recovery system is configured to gather energy from bidirectional tidal currents.

3. The energy storage system of claim 1 wherein the current flow energy recovery system is configured to gather energy from monodirectional flowing currents.

4. The energy storage system of claim 1 wherein the current flow energy recovery system includes:
a turbine generator that is rotated by the moving water source.

5. The energy storage system of claim 4 wherein the current flow energy recovery system includes:
a flow concentration system for directing at least a portion of the moving water source into the turbine generator.

6. The energy storage system of claim 4 wherein the turbine generator includes:
a bulb turbine generator.

7. The energy storage system of claim 1 wherein the storage tank is positioned at least partially above the moving water source.

8. The energy storage system of claim 1 wherein the fluid is water from the moving water source.

9. The energy storage system of claim 1 wherein the fluid source is the moving water source.

10. The energy storage system of claim 1 wherein the obtained energy is electrical energy and the pumping system is an electrical pumping system.

11. The energy storage system of claim 1 wherein the obtained energy is mechanical energy and the pumping system is a mechanical pumping system.

12. The energy storage system of claim 1 further comprising:
a drain system configured to drain a portion of the stored fluid within the storage tank, thus defining drained fluid.

13. The energy storage system of claim 12 further comprising:
an electrical generation system configured to receive the drained fluid and generate electrical energy.

14. The energy storage system of claim 13 wherein the electrical generation system includes:
a turbine generator that is rotated by the drained fluid.

15. An energy storage system comprising:
a current flow energy recovery system configured to obtain energy from a moving water source;
a storage tank configured to store fluid-based potential energy;
a pumping system configured to utilize the obtained energy to pump fluid from a fluid source into the storage tank, thus defining stored fluid;
a drain system configured to drain a portion of the stored fluid within the storage tank, thus defining drained fluid; and
an electrical generation system configured to receive the drained fluid and generate electrical energy.

16. The energy storage system of claim 15 wherein the current flow energy recovery system is configured to gather energy from bidirectional tidal currents.

17. The energy storage system of claim 15 wherein the current flow energy recovery system is configured to gather energy from monodirectional flowing currents.

18. The energy storage system of claim 15 wherein the current flow energy recovery system includes:
a turbine generator that is rotated by the moving water source.

19. The energy storage system of claim 18 wherein the current flow energy recovery system includes:
a flow concentration system for directing at least a portion of the moving water source into the turbine generator.

20. The energy storage system of claim 18 wherein the turbine generator includes:
a bulb turbine generator.

21. The energy storage system of claim 15 wherein the storage tank is positioned at least partially above the moving water source.

22. The energy storage system of claim 15 wherein the fluid is water from the moving water source.

23. The energy storage system of claim 15 wherein the fluid source is the moving water source.

24. The energy storage system of claim 15 wherein the obtained energy is electrical energy and the pumping system is an electrical pumping system.

25. The energy storage system of claim 15 wherein the obtained energy is mechanical energy and the pumping system is a mechanical pumping system.

26. The energy storage system of claim 15 wherein the electrical generation system includes:
a turbine generator that is rotated by the drained fluid.

27. An energy storage system comprising:
a current flow energy recovery system configured to obtain energy from a moving water source, wherein the current flow energy recovery system includes a bulb turbine generator that is rotated by the moving water source;
a storage tank configured to store fluid-based potential energy;
a pumping system configured to utilize the obtained energy to pump fluid from a fluid source into the storage tank, thus defining stored fluid;
a drain system configured to drain a portion of the stored fluid within the storage tank, thus defining drained fluid; and
an electrical generation system configured to receive the drained fluid and generate electrical energy.

28. The energy storage system of claim 27 wherein the current flow energy recovery system is configured to gather energy from bidirectional tidal currents.

29. The energy storage system of claim 27 wherein the electrical generation system includes:
a turbine generator that is rotated by the drained fluid.

30. The energy storage system of claim 27 wherein the current flow energy recovery system includes:
a flow concentration system for directing at least a portion of the moving water source into the bulb turbine generator.
